(19) United States
(12) Patent Application Publication
(10) Pub. No.: US 2026/0011190 A1
(43) Pub. Date: Jan. 8, 2026

(54) Safety System for a Motor Vehicle, Motor Vehicle, and Method for Carrying out a Safety Check on a Motor Vehicle

(71) Applicant: Bayerische Motoren Werke Aktiengesellschaft, Muenchen (DE)

(72) Inventor: Gerald HOELLER, Muenchen (DE)

(21) Appl. No.: 18/992,605

(22) PCT Filed: Jul. 12, 2023
(86) PCT No.: PCT/EP2023/069288

§ 371 Date: Jan. 9, 2025

(30) Foreign Application Priority Data
Aug. 8, 2022 (DE) 10 2022 119 893.6

(51) Int. Cl. G07C 5/08; G07C 5/00

(52) U.S. Cl. CPC G07C 5/0825; G07C 5/008

(57) ABSTRACT

A safety system for a motor vehicle includes a control device designed to carry out a test run. The test run is designed such that when the test run is activated a number of vehicle functions are activated, particularly one after the other and automatically, to test them.

### BACKGROUND AND SUMMARY

The present invention relates to a safety system for a motor vehicle, to a motor vehicle, and to a method for carrying out a safety check on a motor vehicle.

The basic functions of motor vehicles, in particular motorcycles, should be tested regularly before starting a journey. This relates, for example, to the function of the turn signals, the light system, the brake system, the tire air pressure, etc. For the driver, this is usually an annoying activity which is therefore often skipped.

Therefore, it is an object of the present invention to provide a safety system for a motor vehicle, a motor vehicle and a method for carrying out a safety check, which can be conveniently implemented in reality and is therefore suitable for increasing safety.

This object is achieved by means of a safety system, a motor vehicle, and a method, according to the independent claim(s). Further advantages and features emerge from the dependent claims and the description and the accompanying FIGURE.

According to the invention, a safety system for a motor vehicle, in particular for a motorcycle, comprises a control device which is designed to carry out a test run, wherein the test run is designed in such a manner that, when activated, a plurality of vehicle functions are actuated, in particular in succession and automatically, for testing. The great advantage is that the driver need not manually test the various functions. Instead, the test run makes it possible to automatically perform a safety check. Typical functions which are checked in this case are, for example, the following: switching on the turn signals, actuating the horn, switching on the dimmed beam and the high beam, applying the brake pads, locking any trunks and checking the (tire) air pressure. At this point, it should be mentioned that, according to one preferred embodiment, the motor vehicle is, in particular, a motorcycle such as a motorbike or a scooter.

According to one preferred embodiment, the control device is designed in such a manner that the test run is automatically activatable or can be automatically activated. According to one embodiment, the activation or starting of the test run is predefined or predefinable using time control, for example. A driver who knows that he wants to use the motor vehicle at 8 AM daily, for example, can parameterize the safety device in such a manner that it carries out a test run in good time before starting a journey. The driver can either be present during the test run or can be subsequently informed of the result of the test run, for example via a corresponding display unit.

According to one particularly preferred embodiment, the control device is designed to process information from the environment in order to activate the test run. The control device is expediently able to identify whether a driver is present. The presence of the driver may be one aspect which is taken into account in order to decide whether the test run is started.

According to one embodiment, the information comprises: position of a driver; actions and/or gestures of the driver. Taking into account actions and/or gestures of the driver entails the advantage that a test run is not started unintentionally, for example if the driver is only accidentally present in the vicinity of the corresponding motor vehicle.

According to one preferred embodiment, the control device is designed to activate the test run if the presence of a driver and his readiness to depart are identified. According to one embodiment, the safety device is designed to identify when the driver approaches the motor vehicle and puts on his helmet and/or gloves. According to one embodiment, the test run is carried out automatically when this information or these states is/are identified. The driver can expediently directly track the performance of the test run since he is in the vicinity. In particular, he can directly check the flashing of the turn signals, the function of the horn, the light, etc., for example. The results of the test run are additionally expediently also displayed on a suitable display unit of the motor vehicle.

According to one embodiment, the control device comprises a plurality of communication units, in particular receiving units and/or transmitting units, which are designed to interact in order to activate the test run. The communication units are expediently used to achieve the situation in which the surroundings of the motor vehicle can be monitored and evaluated. It is therefore possible, in particular, to identify whether a driver is approaching the motor vehicle and is carrying out certain actions which indicate that the driver actually wishes to drive the motor vehicle.

According to one embodiment, at least one communication unit is or can be assigned to a driver, in particular an article of clothing and/or a mobile device of the driver. An article of clothing is, for example, trousers or a jacket of the driver and/or a helmet and/or the gloves. According to one embodiment, the above-mentioned articles of clothing contain sensors which make it possible to detect a distance from one another, with the result that it is possible, for example, to identify whether a driver puts on his helmet, etc.

According to one embodiment, appropriate software is present or can be actuated on the mobile device of the driver and makes it possible to start the test run manually and remotely. Alternatively, the safety system itself may comprise an operating element that can be used to directly start the test run on the respective motor vehicle. Such an operating element may be a separate button. Alternatively, the operating element is in the form of a menu item in a vehicle display/cockpit, for example of the on-board computer. At this point, it should be mentioned that the safety system is, for example, part of a control device of the motor vehicle. As already mentioned, the safety system expediently comprises a display device which is designed to display the result of the test run. The safety system is expediently designed to concomitantly use a display device which is present on the motor vehicle anyway, for example a screen in a motor vehicle or a cockpit display etc. and/or the display or the screen of a (terminal) device, in particular a mobile (terminal) device, such as a smartphone.

The invention is also directed to a motor vehicle comprising a safety system according to the invention. According to one preferred embodiment, the motor vehicle is, in particular, a motorcycle such as a motorbike or a scooter. However, the motor vehicle may also be a passenger car or a commercial vehicle. In particular, the motor vehicle is a land vehicle.

According to the invention, a method for carrying out a safety check on a motor vehicle comprises the steps of:
automatically actuating a multiplicity of vehicle functions for testing by activating a test run;
providing a control device in a motor vehicle that is designed to carry out the test run.

Expediently, a driver therefore need not independently activate the multiplicity of possible functions. Instead, the test run must be activated only once. This test run then actuates, for example in order, the various functions that are intended to be tested. According to one preferred embodiment, the control device can be parameterized to the effect that it is possible to predefine which functions are intended to be actuated during the test run and which are not. The various functions can therefore be advantageously specified for the safety check. A tire pressure check is not carried out, for example, if the driver has decided that it is not required. Furthermore, it is possible, for example, to specify a test run that is intended to be carried out daily each time before starting a journey. Additionally or alternatively, it is possible to parameterize a test run which is intended to be carried out only before longer trips, exits etc. There may also be parameterizability to the effect that temporal components are also taken into account. This means, for example, that the system can be parameterized in such a manner that no more than one test run is carried out in a day.

According to one preferred embodiment, the method comprises the steps of:
determining the presence of a driver;
determining a driver's intention, in particular a readiness of the driver to depart;
activating the test run if a driver is present and his readiness to depart is identified.

The various functions of the motor vehicle are therefore advantageously not only automatically tested. The safety check or the test run is expediently also automatically activated. According to one preferred embodiment, the result of the safety check is displayed, for example, on a display of the motor vehicle, in particular a motorcycle. Any faults are described and can therefore be rectified in good time. Alternatively or additionally, the result may also be displayed on a (terminal) device, in particular a mobile (terminal) device, such as a smartphone.

The advantages mentioned in connection with the method apply analogously and accordingly to the safety system, and vice versa and with respect to one another.

Further advantages and features emerge from the following description of one embodiment of a safety system or a motor vehicle and a method with reference to the accompanying FIGURE.

### BRIEF DESCRIPTION OF THE DRAWING

FIG. 1: shows a sketch for illustrating one embodiment of the method or a motor vehicle comprising a safety system.

### DETAILED DESCRIPTION OF THE DRAWING

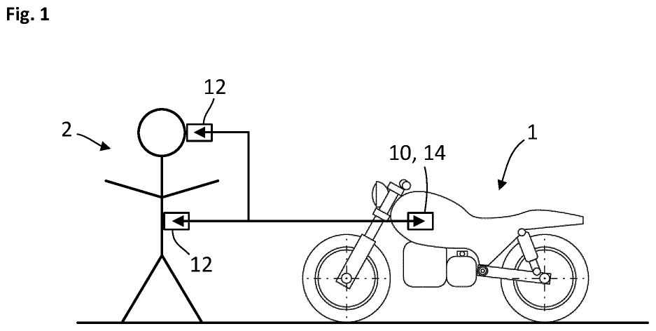

FIG. 1 shows a schematic view of a motor vehicle 1 comprising a safety system 10. A driver 2 is illustrated beside it. It is shown that communication units 12 and 14 are arranged on the driver 2 and on the motor vehicle 1. For example, transmitting units 12 are respectively arranged on a helmet of the driver 2 and on his jacket. A corresponding receiving unit 14 is provided on the motor vehicle 1. Such a configuration makes it possible, for example, for the safety system 10 to be able to identify when a driver 2 is approaching the motor vehicle 1 and puts on his helmet or gloves (not illustrated here). The safety system 10 can subsequently advantageously automatically carry out a safety check. This automatic check involves, for example, switching on all turn signals, actuating the horn, switching on the dimmed beam and the high beam, applying the brake pads, locking the trunks and checking the air pressure. The result of the safety check is displayed on the display of the motorcycle and/or a mobile terminal device, such as a smartphone, of the driver 2. Any faults are described and can therefore be rectified in good time.

### LIST OF REFERENCE SIGNS

1 Motor vehicle
2 Driver
10 Safety system
12 Communication unit, transmitting unit
14 Communication unit, receiving unit

1.-11. (canceled)

12. A safety system for a motor vehicle, comprising:
a control device which is configured to carry out a test run,
wherein the test run is configured such that, when activated, a plurality of vehicle functions are actuated, in succession and automatically, for testing.

13. The safety system according to claim 12, wherein the control device is further configured such that the test run is automatically activated.

14. The safety system according to claim 12, wherein
the control device is configured to process information from an environment of the motor vehicle in order to activate the test run.

15. The safety system according to claim 14, wherein the information comprises: a position of a driver, and actions and/or gestures of the driver.

16. The safety system according to claim 12, wherein
the control device is configured to activate the test run when a driver is present and a readiness of the driver to depart are identified.

17. The safety system according to claim 12, wherein
the control device comprises a plurality of communication units, including a receiving unit and/or a transmitting unit, which are designed to interact in order to activate the test run.

18. The safety system according to claim 17, wherein
at least one communication unit is assigned to a driver, based on an article of clothing and/or a mobile device of the driver.

19. The safety system according to claim 12, further comprising:
a display that displays a result of the test run.

20. A motor vehicle comprising a safety system according to claim 12.

21. A method for carrying out a safety check on a motor vehicle, the method comprising the steps of:
automatically actuating a multiplicity of vehicle functions for testing by activating a test run; and
providing a control device in a motor vehicle that is configured to carry out the test run.

22. The method according to claim 21, further comprising the steps of:
determining a presence of a driver;
determining a driver's intention, including a readiness of the driver to depart; and
activating the test run.
